(19) United States
(12) Patent Application Publication
(10) Pub. No.: US 2002/0049877 A1
(43) Pub. Date: Apr. 25, 2002

(54) Signal converter for transferring data from computer to appliance

(76) Inventor: Chun-Ping Lin, Hsinchu (TW)

Correspondence Address: Drummond & Duckworth, Suite 500, 4590 MacArthur Blvd., Newport Beach, CA, 92660, US

(21) Appl. No.: 09/755,674

(22) Filed: Jan. 4, 2001

(30) Foreign Application Priority Data
Oct. 23, 2000 (TW) 89122266

(51) Int. Cl. G06F 13/12; G06F 13/38

(52) U.S. Cl. 710/305

(57) ABSTRACT

A signal converter for transferring data into an appliance is provided. The signal converter includes a first end connected to a port of a computer for receiving a first signal, a second end connected to a memory device of the appliance via a cable for outputting a second signal, and a controller for converting the first signal into the second signal.

### FIELD OF THE INVENTION

The invention relates to a signal converter for converting an input signal into an output signal, and more particularly to a signal converter electrically connected to a computer for transferring data to an appliance.

### BACKGROUND OF THE INVENTION

Signal converters have been widely used to convert one type signal into another type signal in order to fit in with the signal system of the specific appliance. For example, in the field of digital systems it is often necessary to convert analog signals into digital signals by using a signal converter.

Typically, memory devices are inserted into many appliances, e.g. an electronic dictionary, a digital camera and a toy, for storing data associated with the operation of the appliances. In order to be satisfied with the market, the functions that the appliances can produce need to change for a certain period. Thus, the data stored in the memory devices of the appliances are usually refreshed by placing the memory devices, e.g. a floppy, into a disk cartridge of a computer for downloading an updated data or changing a new floppy. Placing the floppy inserted in the appliance is inconvenient and inefficient because of taking out the floppy from the appliance, and changing a new floppy frequently is costly.

The following example is given to describe the problem occurred in the prior art. Toys that could produce a number of action effects have been commercially successful. Such type of toy was customarily a doll which could speak, laugh, cry, sing, move, dance . . . etc. when a user held or pressed some places of the doll such as a hand, a leg, a head and/or an abdomen. Referring to FIG. 1, in some places of a doll, each has a button 11 that is connected to an action effect generating device disposed in the doll. FIG. 2 shows a typical block diagram of an action-effect generating device disposed in a doll. The action-effect generating device is essentially composed of three components: a switch, a control circuit which is pre-arranged for some special purposes and a terminal apparatus. By touching somewhere in the doll a switch SW is electrically connected; therefore, a Vcc signal is delivered into the control circuit 21. In response to a signal delivered from the control circuit 21, a terminal apparatus, for example a lamp 22, a speaker 23 and/or a motor 24, is disposed in the doll for producing an action effect which is generally sound emitting, illuminating, vibrating and/or moving. The aforementioned toy has been prevailing and commercially available for a long time. However, in the prior art none of the toy provides the user with the ability to change or add extra action effects. In other words, the toy is limited to the action effects contained inside the toy as provided by the manufacturer. If the action effect produced from the toy is invariable and immutable, the toy will be found monotonous and never appeal to a child again and soon such toy will be discarded or left aside, which is costly and not environmentally friendly. Even if the memory device, for example an Electrically Programmable Read-Only Memory (EEPROM) or a flash memory, inserted into the toy is replaced or refreshed with a new one, the high cost and inconvenience could not be avoided.

Therefore, the present invention provides a signal converter electrically connected to a computer for transferring data to an appliance for overcoming the problems described above.

### SUMMARY OF THE INVENTION

An object of the present invention is to provide a signal converter electrically connected to a computer for transferring data to an appliance.

It is another object of the present invention to provide a method for downloading updated data from a computer to an appliance.

In accordance with the present invention, the signal converter includes a first end connected to a port of a computer for receiving a first signal, a second end connected to a memory device of said appliance via a cable for outputting a second signal, and a controller for converting the first signal into the second signal.

In accordance with an aspect of the present invention, the appliance is a toy. The port is electrically connected to a computer and the computer can be further linked to Internet. The port is preferably a serial port, e.g. a universal serial bus (USB) and a RS232 port, and the first signal is a serial signal. The cable is preferably a RJ-45 cable. The second signal is preferably a digital signal. Certainly, the memory device can be one of an Electrically Programmable Read-Only Memory (EEPROM) and a flash memory.

In accordance with another aspect of the present invention, the port can be a parallel port, e.g. a print port, and the first signal is a parallel signal.

According to the present invention, the method for downloading refreshed data from a computer to an appliance includes steps as follows. First, an appliance having a memory device is provided. Then the memory device is electrically connected with a computer via a signal converter. The signal converter includes a first end for receiving a first signal, a second end connected to the memory device for outputting a second signal and a controller for converting the first signal into the second signal. Finally, download data from said computer to the memory device for refreshing data stored in the appliance. Preferably, the computer is linked to a network server, such as Internet. Thus, the data stored in the memory device of the appliance is refreshed via the signal converter.

In accordance with another aspect of the present invention, the appliance is a toy. The computer can be further linked to Internet. The port is preferably a serial port, e.g. a universal serial bus (USB) and a RS232 port, and the first signal is a serial signal. The cable is preferably a RJ-45 cable. The second signal is preferably a digital signal. Certainly, the memory device can be one of an Electrically Programmable Read-Only Memory (EEPROM) and a flash memory.

In accordance with another aspect of the present invention, the port can be a parallel port, e.g. a print port, and the first signal is a parallel signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a customarily used doll capable of producing action effects;

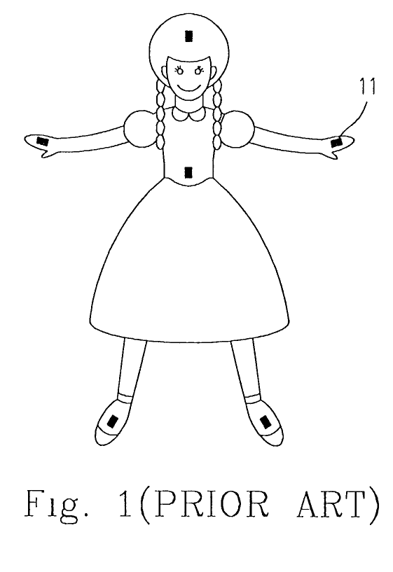

FIG. 2 is a typical block diagram of an action effect generating device disposed in a doll;

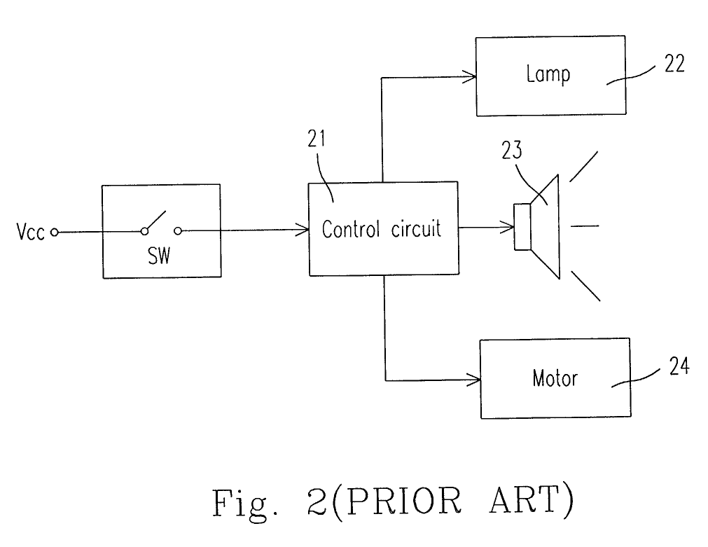

FIG. 3 is a schematic diagram illustrating a method for downloading refreshed data from a computer via a signal converter according to the present invention;

FIG. 4 is a schematic diagram illustrating the data exchange via the signal converter according to the first preferred embodiment of the present invention;

FIG. 5 is a schematic diagram illustrating the data exchange via the signal converter according to the second preferred embodiment of the present invention; and

FIG. 6 is a schematic diagram illustrating the data exchange via the signal converter according to the third preferred embodiment of the present invention.

### DETAILED DESCRIPTION OF THE PREFERRED EMBODIMENTS

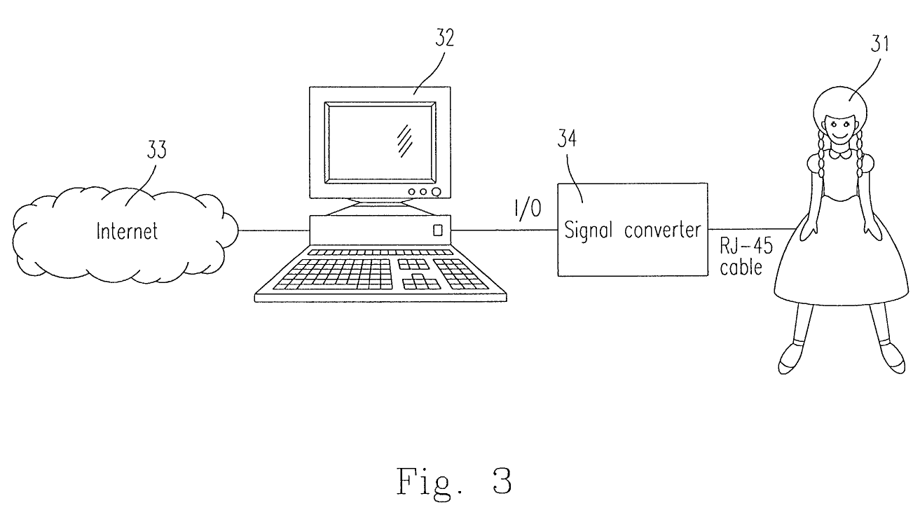

FIG. 3 is a schematic diagram illustrating a method for downloading refreshed data from a computer via a signal converter according to the present invention. The computer 32 is linked to Internet 33. The desirable data or software files can be downloaded from the Internet 33 into the toy 31 via a signal converter 34. One end of the signal converter 34 is connected to the input/output port (I/O) of the computer 32, and the other end of the signal converter 34 is connected to the toy 31 through a RJ-45 cable.

The input/output port of a computer generally includes two types:

the serial port and the parallel port. The customarily used serial port includes a universal serial bus (USB) and an RS-232 serial port. The typical parallel port is a print port.

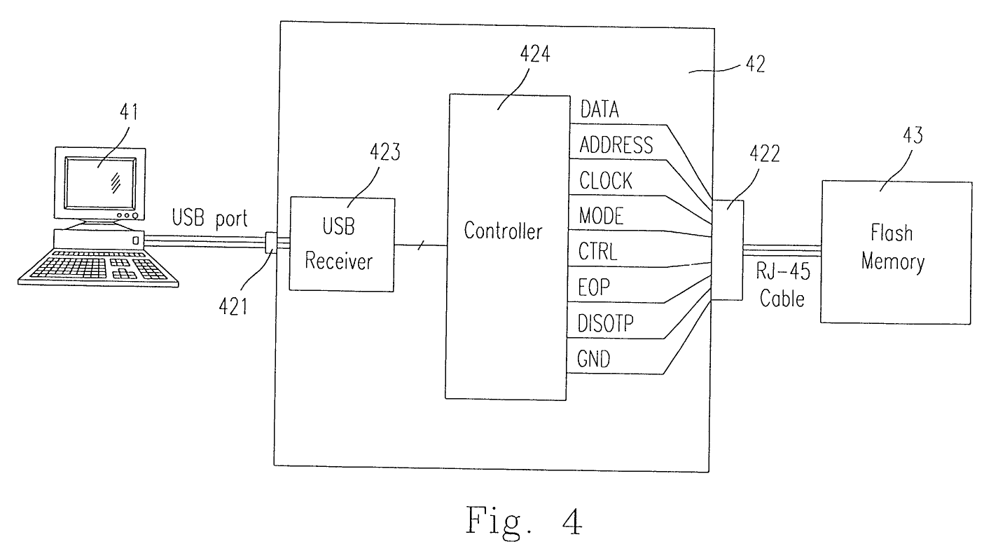

FIG. 4 is a schematic diagram illustrating the data exchange via the signal converter according to the first preferred embodiment of the present invention. The signal converter 42 includes a first end 421 connected to the USB port of a computer 41, a second end 422 connected to a flash memory 43 through a RJ-45 cable, a USB receiver 423 and a controller 424. The data stored in the computer 41 is transferred into a serial signal form, then converted into a digital signal form by the signal converter 42. The digital signal, for example DATA, ADDRESS, CLOCK, MODE, CTRL, EOP, DISOTP and GND, is then delivered into the flash memory 43 to refresh data stored in the flash memory 43.

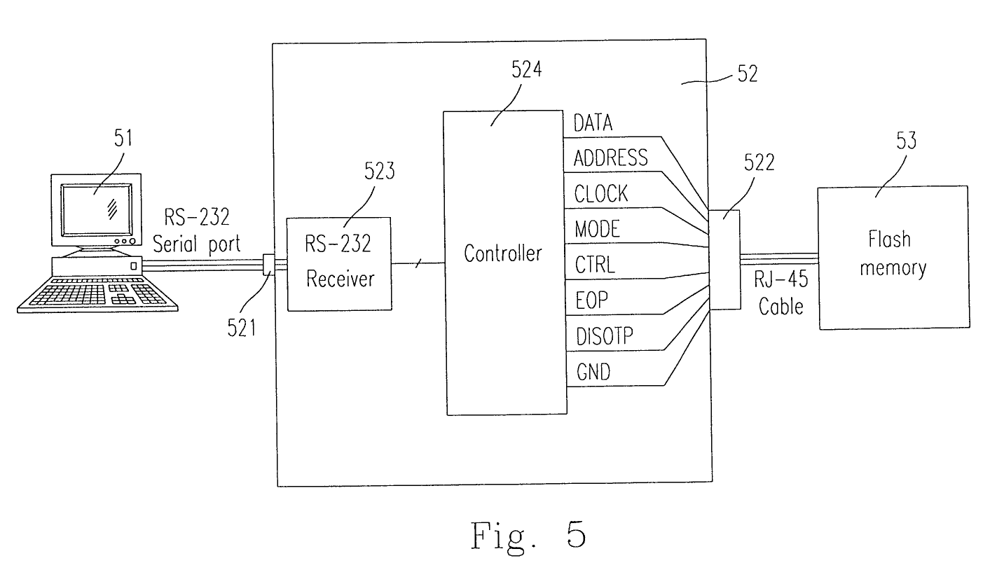

FIG. 5 is a schematic diagram illustrating the data exchange via the signal converter according to the second preferred embodiment of the present invention. The signal converter 52 includes a first end 521 connected to the RS-232 port of a computer 51, a second end 522 connected to a flash memory 53 through a RJ-45 cable, a RS-232 receiver 523 and a controller 524. The data stored in the computer 51 is transferred into a serial signal form, then converted into a digital signal form by the signal converter 52. The digital signal is then delivered into the flash memory 53 to refresh data stored in the flash memory 53.

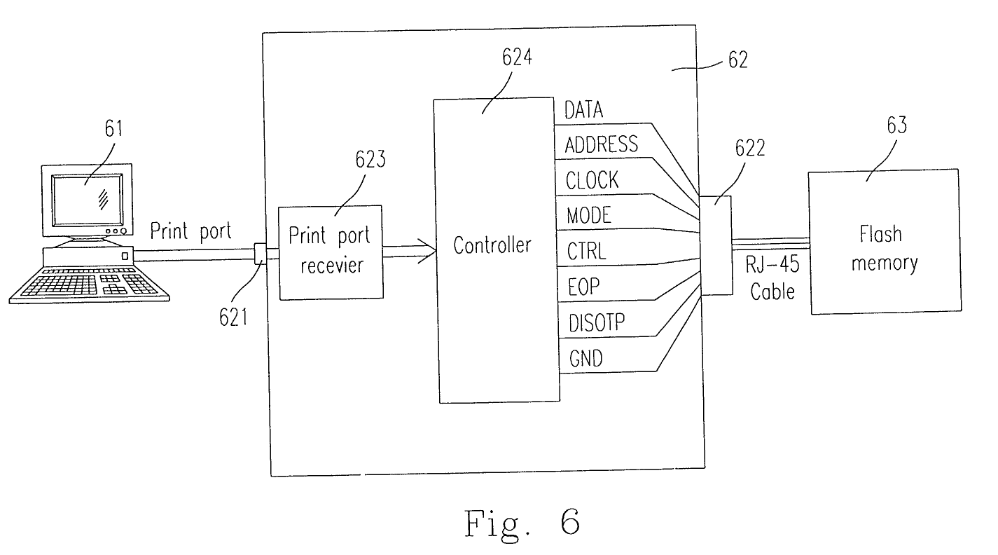

FIG. 6 is a schematic diagram illustrating the data exchange via the signal converter according to the third preferred embodiment of the present invention. The signal converter 62 includes a first end 621 connected to the parallel port, e.g. a print port, of a computer 61, a second end 622 connected to a flash memory 63 through a RJ-45 cable, a print port receiver 623 and a controller 624. The data stored in the computer 61 is transferred into serial signals, then converted into a digital signal form by the signal converter 62. The digital signalis then delivered into the flash memory 63 to refresh data stored in the flash memory 63.

Certainly, the computer in the above embodiment can be linked to Internet, thereby downloading a new file or data from a website provided by the toy suppliers. As described above in detail, it is apparent that using the signal converter of the present invention can provide a doll with additional action effects by updating new software files even if it could originally only produce one action effect. Not only the original action effect but also the refreshed action effect can be displayed without changing any hardware. Furthermore, the method of the present invention for downloading refreshed data from a computer is more convenient and less cost because the memory device inserted in the toy is needless to be replaced and the refreshed data is obtained from Internet.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structure.

What is claimed is:

1. A signal converter for transferring data into an appliance comprising:
a first end connected to a port of a computer for receiving a first signal;
a second end connected to a memory device of said appliance via a cable for outputting a second signal; and
a controller for converting said first signal into said second signal.

2. The signal converter according to claim 1, wherein said appliance is a toy.

3. The signal converter according to claim 1, wherein said memory device is one of an Electrically Programmable Read-Only Memory (EEPROM) and a flash memory.

4. The signal converter according to claim 1, wherein said computer is further linked to Internet.

5. The signal converter according to claim 1, wherein said second signal is a digital signal.

6. The signal converter according to claim 5, wherein said port is a serial port and said first signal is a serial signal.

7. The signal converter according to claim 5, wherein said port is a parallel port and said first signal is a parallel signal.

8. The signal converter according to claim 7, wherein said parallel port is a print port.

9. A method for downloading refreshed data from a computer to an appliance, comprising steps of:
providing an appliance having a memory device;
electrically connecting said memory device with a computer via a signal converter comprising a first end for receiving a first signal, a second end connected to said memory device for outputting a second signal and a controller for converting said first signal into said second signal; and
downloading data from said computer to said memory device for refreshing data stored in said appliance.

10. The method according to claim 9, wherein said appliance is a toy.

11. The method according to claim 9, wherein said memory device is one of an Electrically Programmable Read-Only Memory (EEPROM) and a flash memory.

12. The method according to claim 9, wherein said computer is further linked to Internet.

13. The method according to claim 9, wherein said second signal is a digital signal.

14. The method according to claim 13, wherein said port is a serial port and said first signal is a serial signal.

15. The method according to claim 13, wherein said port is a parallel port and said first signal is a parallel signal.

16. The method according to claim 15, wherein said parallel port is a print port.
